(19) United States
(12) Patent Application Publication
(10) Pub. No.: US 2004/0161199 A1
(43) Pub. Date: Aug. 19, 2004

(54) Photonic crystal fiber coupler and fabricating method thereof

(76) Inventors: Sung-Koog Oh, Kumi-shi (KR); Mun-Hyun Do, Chilgok-gun (KR); Byeong-Ha Lee, Kwangjukwangyok-shi (KR); Un-Chul Paek, Kwangjukwangyok-shi (KR); Jin-Chae Kim, Inchonkwangyok-shi (KR); Joo-Beom Eom, Ulsankwangyok-shi (KR); Dae-Seung Moon, Seoul (KR)

Correspondence Address: CHA & REITER, LLC, 210 ROUTE 4 EAST STE 103, PARAMUS, NJ, 07652, US

(21) Appl. No.: 10/365,966

(22) Filed: Feb. 13, 2003

(51) Int. Cl. G02B 6/26; G02B 6/20

(52) U.S. Cl. 385/43; 385/50; 385/125

(57) ABSTRACT

Disclosed is a photonic crystal-fiber coupler that can distribute light while maintaining the inherent optical properties of photonic crystal fibers. The inventive photonic crystal-fiber coupler comprises at least two photonic crystal fibers and at least one coupling region longitudinally formed along the part of each photonic crystal fiber. Each photonic crystal fiber has a core portion and a cladding portion and includes a plurality of longitudinal holes formed in such a manner to surround the core portion.

### BACKGROUND OF THE INVENTION

1. Field of the Invention

The present invention generally relates to an optical coupler and, more particularly, to a photonic crystal-fiber coupler that can distribute light while maintaining inherent optical properties of the photonic crystal fibers, and a fabricating method thereof.

2. Description of the Related Art

A single-mode optical fiber generally uses a glass material with added germanium or phosphorous as its core member. At the same time, the photonic crystal fiber, as shown in FIG. 1, is made of a substantially transparent, single solid-phase material, such as fused silica glass 1, inside of which a regular array of air holes extend in parallel along its entire length with the axis of a fiber. The regular array of air holes have a configuration such that no air hole exists at the center of a fiber, so that it can act as a substitute for the core of a common optical fiber, thereby reducing optical loss due to additives other than glass.

The photonic crystal fiber possesses many important characteristics. For example, it can support a single-mode transmission over a wide range of wavelengths, deliver a high optical power because it has a large mode region, and can yield a large negative dispersion at an optical communication wavelength of 1.55 μm. As such, the photonic crystal fiber lately has been receiving a lot of attention as an alternate optical element for increasing nonlinearity, reducing nonlinearity, adjusting polarization, and so forth. Accordingly, the photonic crystal fiber having such a broad functionality is expected to be widely applied in the optical communications and in the optical industry in the near future.

Briefly, a photonic crystal fiber can be fabricated by positioning a pure silica-glass rod in a center portion corresponding to the core of a common optical fiber, surrounding the silica-glass rod with a multi-layer silica tube as tightly as possible to form a tube layer corresponding to the cladding portion of a common optical fiber, and then fusing them together and simultaneously drawing them downward.

Meanwhile, an optical coupler is a passive element for branching off or coupling an optical signal. An optical coupler using an optical fiber, which has been in the widest use until now, is a fused coupler, and the fused coupler is manufactured by twisting several pieces of optical fiber together, then fusing and drawing the twisted optical fibers at the same time. All dielectric-type single-mode waveguides, including optical fibers, employ a coupling mode in which two waveguides are coupled to each other by an evanescent field attenuating exponentially outside the core of a waveguide. Thus, if two waveguides lie adjacent to each other, a wave guiding mode is excited by an evanescent field of the adjoining waveguide and optical signals of two waveguides are coupled to each other. This type of coupling is referred to as an evanescent field coupling and the fused coupler utilizes such a coupling.

A common single-mode fiber, however, becomes a multiple mode at a wavelength of 1.3 μm or less. Thus, there are drawbacks in using optical-communication elements based upon an optical fiber and an optical coupler when using a wavelength of a near-infrared ray or a visible ray shorter than 1.3 μm due to the problems associated with the bandwidth restriction, noise, or the like.

### SUMMARY OF THE INVENTION

Accordingly, the present invention has been designed to solve the above-mentioned problem occurring in the prior art and provides additional advantages, by providing a photonic crystal-fiber coupler capable of distributing light while maintaining the inherent optical properties of the photonic crystal fibers and a fabricating method thereof.

One aspect of the present invention is to provide a photonic crystal-fiber coupler, which can furnish a single mode over a wide range of wavelengths, and a fabricating method thereof.

According to another aspect of the invention, there is provided a photonic crystal-fiber coupler comprising: at least two photonic crystal fibers, each having a core portion and a cladding portion and includes a plurality of longitudinal holes formed in such a manner to surround the core portion; and, at least a coupling region longitudinally formed along a part of each photonic crystal fiber.

According to a further aspect of the present invention, a method for fabricating a photonic crystal-fiber coupler is provided and includes the steps of: fusing and drawing at least two photonic crystal fibers to combine them with each other, each of the photonic crystal fibers having a plurality of longitudinal holes, wherein the fusing and drawing step continues until the light flowing through one photonic crystal fiber passes to the other photonic crystal fiber.

### BRIEF DESCRIPTION OF THE DRAWINGS

The above objects, features, and advantages of the present invention will be more apparent from the following detailed description taken in conjunction with the accompanying drawings, in which:

FIG. 1 is a schematic cross-sectional view of a common photonic crystal fiber;

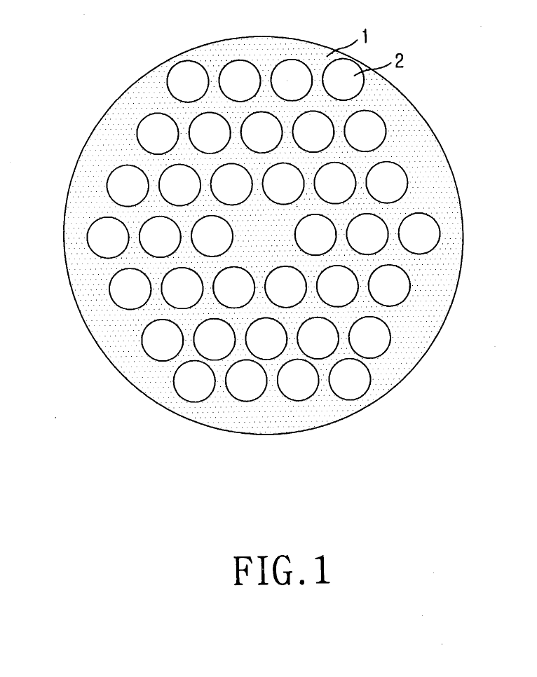

FIGS. 2a and 2b are scanning electron micrographs of the two photonic crystal fibers used in a preferred embodiment of the present invention;

FIG. 3 is a constructional view of a coupler fabricated using two pieces of photonic crystal fibers having four air holes in accordance with a preferred embodiment of the present invention;

FIG. 4 is a sectional view of a coupling region of the coupler shown in FIG. 3;

FIG. 5 is a graph showing the output characteristic of a first photonic crystal fiber (A) and the output characteristic of a second photonic crystal characteristic (B) according to the drawing length of the coupler;

FIG. 6 is a schematic constructional view of the fusing and drawing device for fabricating a photonic crystal-fiber coupler in accordance with the present invention;

FIG. 7 is a graph showing a transmission characteristic of the photonic crystal-fiber coupler having multi-layers of air holes in accordance with a preferred embodiment of the present invention; and,

FIG. 8 is a graph showing an optical-coupling ratio of the photonic crystal-fiber coupler in accordance with a preferred embodiment of the present invention.

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. For the purposes of clarity and simplicity, a detailed description of known functions and configurations incorporated herein will be omitted as it may make the subject matter of the present invention unclear.

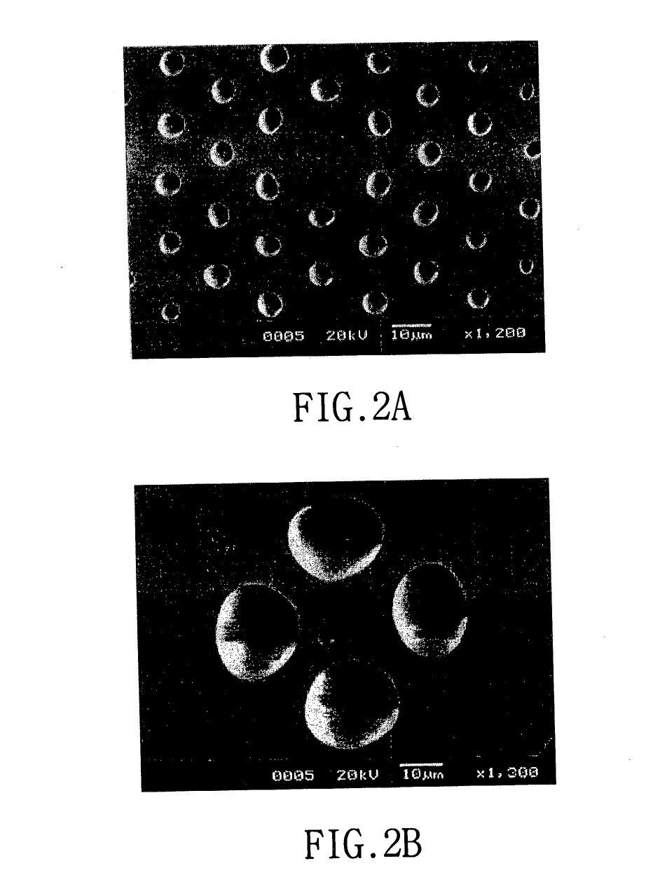

FIGS. 2a and 2b show sectional electron micrographs of two photonic crystal fibers according to the preferred embodiment of the present invention. In particular, FIG. 2a shows, in section, a photonic crystal fiber having five layers of air holes each of which is about 4 μm in size and having a spacing of 10 μm there-between, and FIG. 2b shows, in section, a photonic crystal fiber having four air holes each of which is about 17 μm in size and which have a spacing of 37 μm there-between.

Optical characteristics of a photonic crystal fiber vary according to the size of air holes and spacing there-between, thus it is possible to manufacture optical elements having diverse characteristics by properly adjusting the size and the spacing of the air holes.

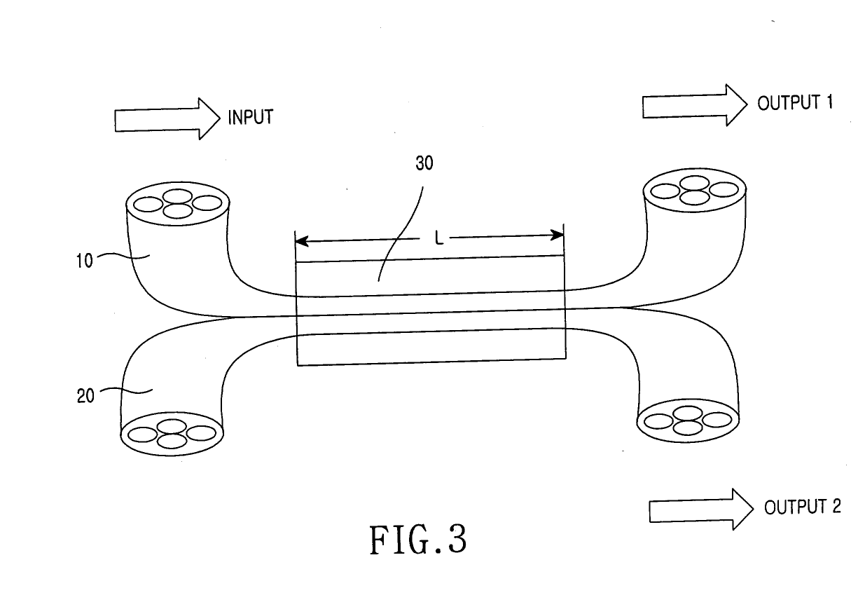

FIG. 3 shows the construction of a coupler fabricated in accordance with one preferred embodiment of the present invention using two pieces of photonic crystal fibers having four air holes, as shown in FIG. 2b.

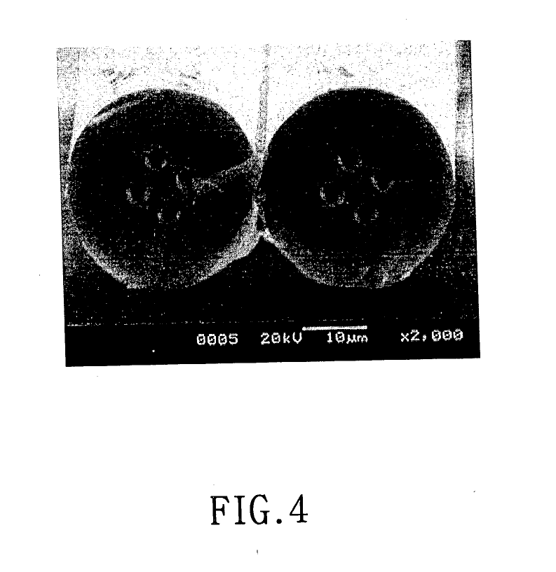

As shown in FIG. 3, the photonic crystal-fiber coupler comprises two pieces of photonic crystal fiber—that is, a first photonic crystal fiber 10 and a second photonic crystal fiber 20—and a coupling region 30 formed by fusing the two pieces of photonic crystal fiber. The section of the coupling region 30 is as shown in FIG. 4.

Referring to FIGS. 3 and 4, an optical signal propagating through the first photonic crystal fiber 10 is coupled to the second photonic crystal fiber 20 via the coupling region 30. A coupling ratio is determined by the length of the coupling region 30. In this example, the coupling of the optical signal began when the coupling region 30 was drawn to have a length of 2.8 mm, and a coupling ratio of 5:5 was obtained when the coupling region 30 was drawn to have a length of 7.2 mm. In the embodiment, the two photonic crystal fibers are coupled together along a longitudinal surface by fusing and drawing the photonic crystal fibers until a light flowing through one photonic crystal fiber passes to the other photonic crystal fiber.

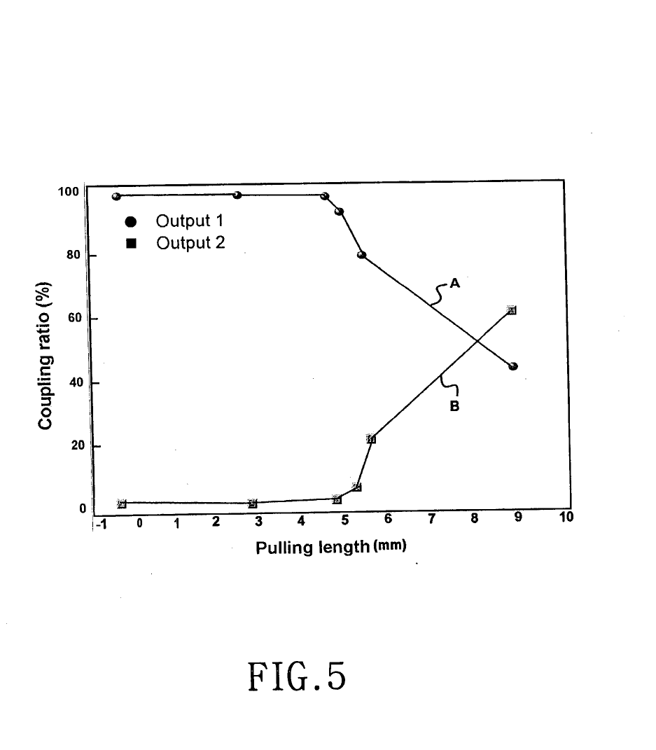

FIG. 5 is a graph showing the output characteristic of a first photonic crystal fiber (A) and the output characteristic of a second photonic crystal characteristic (B) according to the length of the photonic crystal-fiber coupler, by which a coupling ratio according to the length of the coupling region can be observed.

In alternate embodiment, the coupling begins when the coupling region drawn with a length of 6 mm using the photonic crystal fiber having five stacks of air holes as shown in FIG. 2a from the solid defect, which is in the center. This means that the length of the coupling region is longer than the case where the photonic crystal fiber has four air holes as the field confinement of 5 stack fiber is longer than 4 hole fiber.

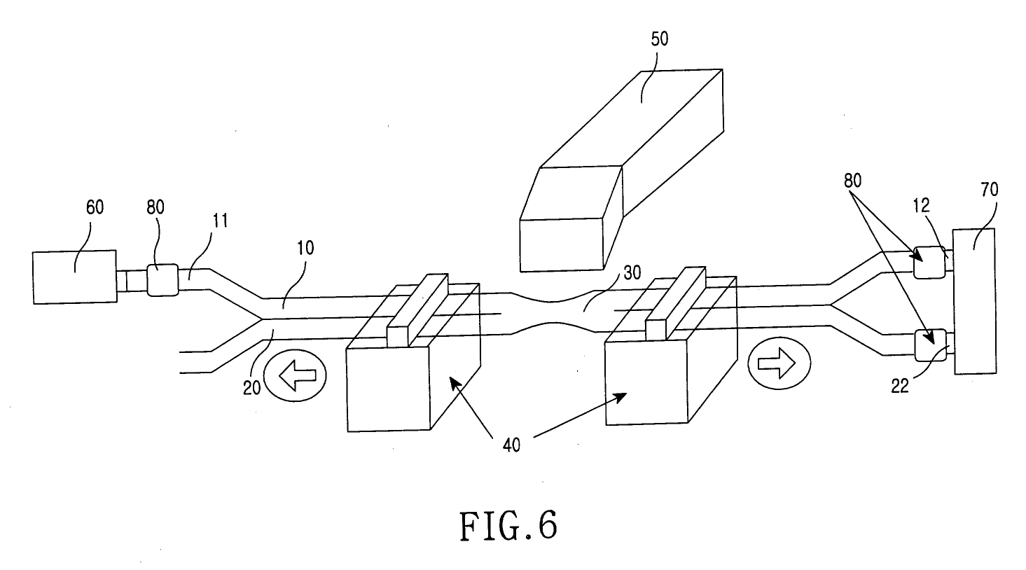

FIG. 6 is a schematic diagram showing the construction of a fusing and drawing device used to fabricate a photonic crystal-fiber coupler using a photonic crystal fiber.

Initially, two pieces of photonic crystal fiber having four air holes and an outer diameter of 125 μm are prepared, for example. Coatings on the sides of the respective fibers, to which heat will be applied, are peeled off over a length of 3 cm, the two pieces of photonic crystal fibers are twisted together and placed on the drawing stages 40, then the twisted photonic crystal fibers are drawn while being subjected to heat from a small hydrogen torch 50 or a CO₂ laser.

Meanwhile, the amount o f drawing is determined in consideration of the output characteristic with respect to an input optical signal because the coupling ratio varies according to the length of the drawn fiber. In this example, the amount of drawing is determined by inputting an optical signal having central wavelengths of 1.3 μm and 1.5 μm and providing a wide wavelength characteristic into one piece of photonic crystal fiber 10 using a light-emission diode 60 and analyzing the transmission spectrums of output optical signals from the respective output terminals 12 and 22 using a photo-spectrometer 70. Here, the photonic crystal fiber is elongated until it provides a desired coupling ratio at the out ports of the coupler. The length of photonic crystal fiber used in this example is 1.5 m and its both ends are mounted to the light-emission diode 60 and the photo-spectrometer 70 by means of a bare fiber adapter 80, respectively. As such, the coupling loss can be minimized by directly mounting the photonic crystal fiber to the input and output terminals.

Referring again to FIG. 4, it can be seen that an outer diameter of the photonic crystal fiber is 125 μm prior to fusing and drawing but is reduced to 30 μm—that is, approximately a quarter of 125 μm after drawing. Note that the two pieces of photonic crystal fibers, using the drawing technique above, are coupled well to each other even after fusing and drawing.

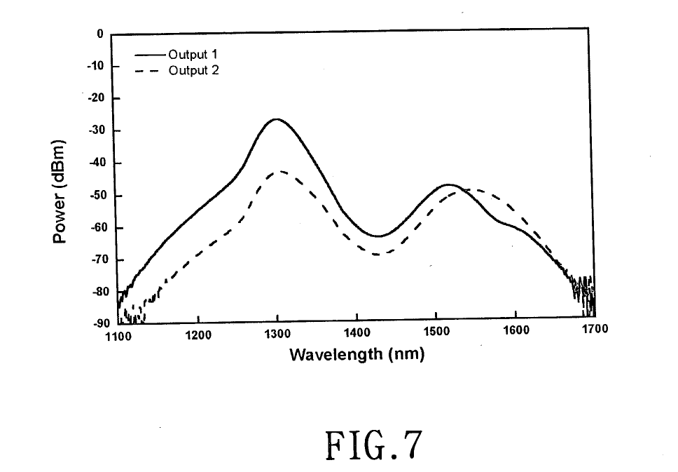

FIG. 7 is a spectrum graph showing the transmission characteristic of the photonic crystal fiber coupler having multi-layers of air holes. As shown, a light-emission diode having a central wavelength of 1.3 μm and 1.5 μm and exhibiting a wide wavelength characteristic is used as a light source, and the transmission loss of the photonic crystal fiber is greatly reduced to 0.2 dB/m due to the hole-to-hole reduction of the fiber.

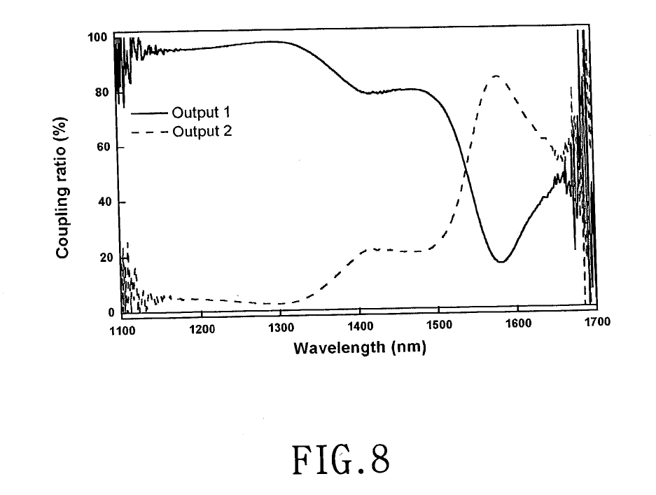

FIG. 8 shows an optical-coupling ratio of the photonic crystal-fiber coupler in accordance with the present invention. It can be seen from the drawing that a coupling ratio of about 4:6 is obtained at a wavelength of 1550 μm.

As described above, a photonic crystal-fiber coupler in accordance with the present invention can distribute an optical signal to two or more optical fibers at a constant ratio while maintaining various inherent characteristics of the photonic crystal fiber as well as the functions of light distribution and wavelength splitting that a common single-mode fiber optic coupler exhibits. In addition, as the photonic crystal-fiber coupler maintains a single-mode characteristic over a wide range of wavelengths, it can be widely applied in a measuring field and an optical-communication field even at a wavelength of 1.3 μm or less which is difficult to implement using the conventional techniques.

While the invention has been shown and described with reference to certain preferred embodiments thereof, it will be understood by those skilled in the art that various changes in form and details may be made therein without departing from the spirit and scope of the invention. Accordingly, the scope of the invention should not be limited to the embodiments, but should be defined by the appended claims and equivalents thereof.

What is claimed is:

1. A photonic crystal-fiber coupler comprising:
at least two photonic crystal fibers, each having a core portion and a cladding portion and includes a plurality of longitudinal holes surrounding the core portion; and
at least one coupling region longitudinally formed along a part of each photonic crystal fiber.

2. The photonic crystal-fiber coupler according to claim 1, wherein the photonic crystal fiber has the core portion and the cladding portion comprised of silica-glass material.

3. The photonic crystal-fiber coupler according to claim 1, wherein optical characteristics of the photonic crystal fiber vary according to a size of the longitudinal holes and spacing between the longitudinal holes.

4. The photonic crystal-fiber coupler according to claim 3, wherein the longitudinal holes of the photonic crystal fiber are 0.1 μm to 500 μm in size, 1 μm to 1000 μm in spacing there-between and 3 to 1000 in number.

5. The photonic crystal-fiber coupler according to claim 1, wherein at least two photonic crystal fibers comprise at least four longitudinal holes surrounding the core portion.

6. The photonic crystal-fiber coupler according to claim 1, wherein at least two photo crystal fibers are coupled to each other along a longitudinal direction.

7. The photonic crystal-fiber coupler according to claim 6, wherein at least two photo crystal fibers are coupled to each other by fusing them together.

8. A method for fabricating a photonic crystal-fiber coupler, the method comprising the step of:
fusing and drawing at least two photonic crystal fibers having a plurality of longitudinal holes; and
coupling at least two photonic crystal fibers together along a longitudinal surface thereof,
wherein the steps of fusing and drawing continue until a light flowing through one photonic crystal fiber passes to the other photonic crystal fiber via the joined longitudinal surface.

9. The method according to clam 8, wherein fusing of the fusing and drawing step is conducted by means of hydrogen flame.

10. The method according to claim 8, wherein fusing of the fusing and drawing step is conducted by means of a CO₂ laser.
